(19) United States
(12) Patent Application Publication
(10) Pub. No.: US 2019/0283856 A1
(43) Pub. Date: Sep. 19, 2019

(54) PANEL STRUCTURE OF OPTIMALLY CONSTRUCTED AND SUBSEQUENTLY INTEGRATED COMPONENTS AND METHOD OF MAKING SAME

(71) Applicant: SPIRIT AEROSYSTEMS, INC., WICHITA, KS (US)

(72) Inventors: Brian Charles Clapp, Goddard, KS (US); James Edward Westerman, Derby, KS (US); Blaise Francis Bergmann, Clearwater, KS (US); Aaron Rae Heitmann, Andover, KS (US)

(73) Assignee: SPIRIT AEROSYSTEMS, INC., WICHITA, KS (US)

(21) Appl. No.: 15/919,831

(22) Filed: Mar. 13, 2018

(51) Int. Cl. B64C 1/12; B64C 1/06; B64C 3/26; B64C 3/18; B32B 7/12; B32B 3/28; B32B 3/12; B32B 5/18

(52) U.S. Cl. CPC B64C 1/12; B64C 1/064; B64C 3/26; B64C 3/182; B32B 2250/02; B32B 3/28; B32B 3/12; B32B 5/18; B32B 2605/18; B32B 7/12

(57) ABSTRACT

A panel structure, for an aircraft fuselage or wing, including a skin component and a stringer sheet component which are independently constructed and then subsequently integrated to form the panel structure. The skin is constructed and consolidated in a first process, and the stringer sheet is constructed and consolidated in a second process which is independent of the first process. Because the skin and stringer sheet are independently constructed, they may, with less compromise, be constructed with the same or different materials, using the same or different techniques, and at the same or different times to optimize each component. The stringers form cavities, and the cavities may be unfilled or filled with material. The skin and stringer sheet are bonded together in a third process, which is independent of the first and second processes. A frame component may be attached to the panel structure in a fourth process.

### FIELD

The present invention concerns composite panel structures and methods of making them, and more particularly, embodiments concern a composite panel structure, such as is used in the fuselages and wings of aircraft or other body components of vehicles, including a skin component and a stringer sheet component which are independently constructed and then subsequently integrated to form the unitary panel structure, and a method of making such a panel structure.

### BACKGROUND

Stringers are longitudinal members used to reinforce skins in panels, such as the panels used in the fuselages and wings of aircraft. The stringers function to divide the skin into distinct sections, which allows the skin to safely buckle, controls circumferential damage to the skin, and provides stiffness against body-bending loads. In one implementation, individual stringers are constructed as distinct pieces that are attached to the skin using fasteners, welding, or bonding. In another implementation, a plurality of stringers is constructed in the form of a stringer sheet, or sheet stringer. With a stringer sheet, one or more composite plies are continuously joined to the inside of the skin, except where the plies are shaped to form concavities or convexities relative to the skin to create the stringers. The skin and stringers are typically constructed using the same or at least compatible materials in a single process, which often requires compromise in their design and construction, and a less than optimal overall panel structure.

This background discussion is intended to provide information related to the present invention which is not necessarily prior art.

### SUMMARY

Embodiments address the above-described and other problems and limitations of the prior art by providing a panel structure, such as may be used in the fuselages and wings of aircraft or other bodies of vehicles, including a skin component and a stringer sheet component which are independently constructed and then subsequently integrated to form the unitary panel structure, and a method of making such a panel structure. As used herein, “independently constructed” means that the skin and stringer sheet components are not constructed in such a manner that the materials, construction, consolidation, and/or timing decisions for one component dictate the decisions for the other component, which allows for optimizing each component for its particular purpose.

In a first embodiment, a method is provided for making a panel structure for a body of a vehicle. Broadly, the method may include the following. A skin component may be constructed and consolidated in a first process to create an at least partially finished skin component. A stringer sheet component may be constructed and consolidated in a second process, which is independent of the first process, to create an at least partially finished stringer sheet component having a plurality of stringers. The at least partially finished skin component and the at least partially finished stringer sheet component may be integrated in a third process, which is independent of the first and second processes, to make the panel structure.

In a second embodiment, a panel structure is provided for a body of a vehicle. The panel structure may include a skin component and a stringer sheet component. The skin component may be constructed and consolidated in a first process to create an at least partially finished skin component. The stringer sheet component may be constructed and consolidated in a second process, which is independent of the first process, to create an at least partially finished stringer sheet component having a plurality of stringers. The at least partially finished skin component and the at least partially finished stringer sheet component may be integrated in a third process, which is independent of the first and second processes, to make the panel structure.

Various implementations of the foregoing embodiments may include any one or more of the following features. The vehicle may be an aircraft, and the panel structure may be for a fuselage or a wing of the aircraft. One or more tear straps may be incorporated into the skin component. The skin component and the stringer sheet component may be constructed of different materials. At least some of the stringers may form cavities, and at least some of the cavities may be filled, such as with a lightweight closed cell foam or a honeycomb core. The at least partially finished skin component and the at least partially finished stringer sheet component may be integrated by bonding them together using an adhesive. A frame component may be attached to the panel structure in a fourth process which is independent of the first, second, and third processes.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a fragmentary isometric view of an example aircraft having a fuselage incorporating an example panel structure;

FIG. 2 is an exploded isometric view of a portion of the fuselage of FIG. 1 showing details of the example panel structure;

FIG. 3 is an exploded isometric view of an embodiment of a panel structure of the present invention;

FIG. 4 is an exploded isometric view of an implementation of the panel structure of FIG. 3;

FIG. 5 is a fragmentary isometric view of a portion of the panel structure of FIG. 3 or 4;

FIG. 6 is an isometric view of the panel structure of FIG. 3 or 4; and

FIG. 7 is a flowchart of steps involved in an embodiment of a method of making a panel structure, such as the panel structure of FIG. 3 or 4.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly, embodiments concern a panel structure, such as may be used in the fuselages and wings of aircraft or other bodies of vehicles, including a skin component and a stringer sheet component which are independently constructed and then subsequently integrated to form the unitary panel structure, and a method of making such a panel structure. The stringer sheet may include a plurality of stringers. Some or all of the stringers may have internal cavities which may be left hollow or filled to increase structural performance. A frame component may be subsequently attached to the integrated skin and stringer sheet. Embodiments advantageously provide a more weight-efficient solution for meeting the structural performance requirements and loading environments of particular applications. In particular, because the individual components are independently constructed, the materials and the processes used to construct each component can be optimized for that particular component, which enables an overall more optimized structural system solution.

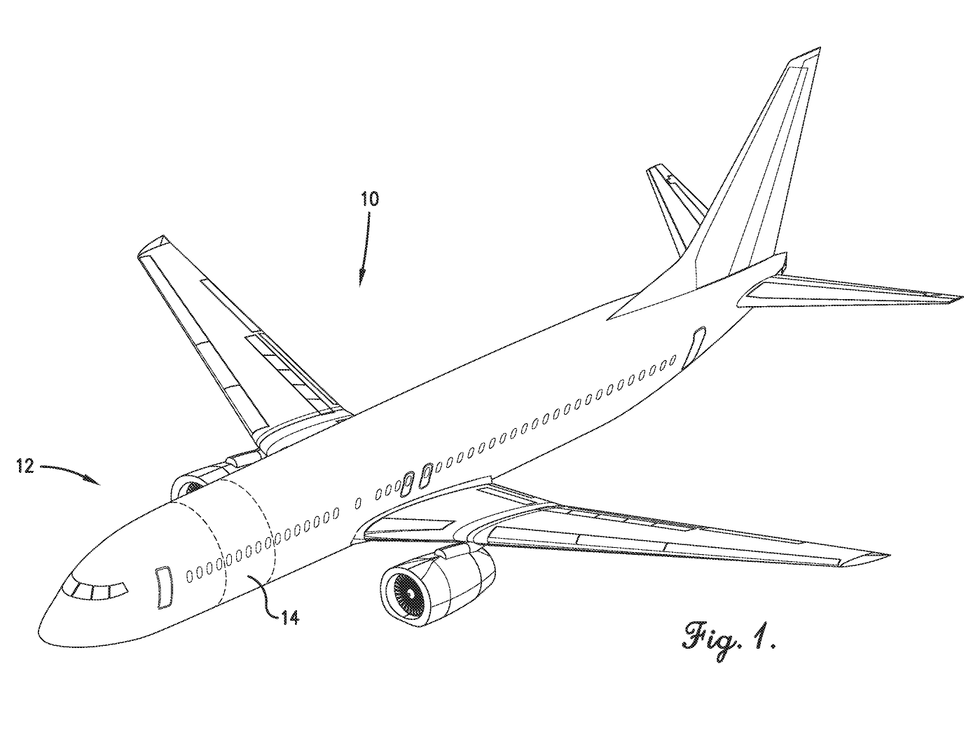

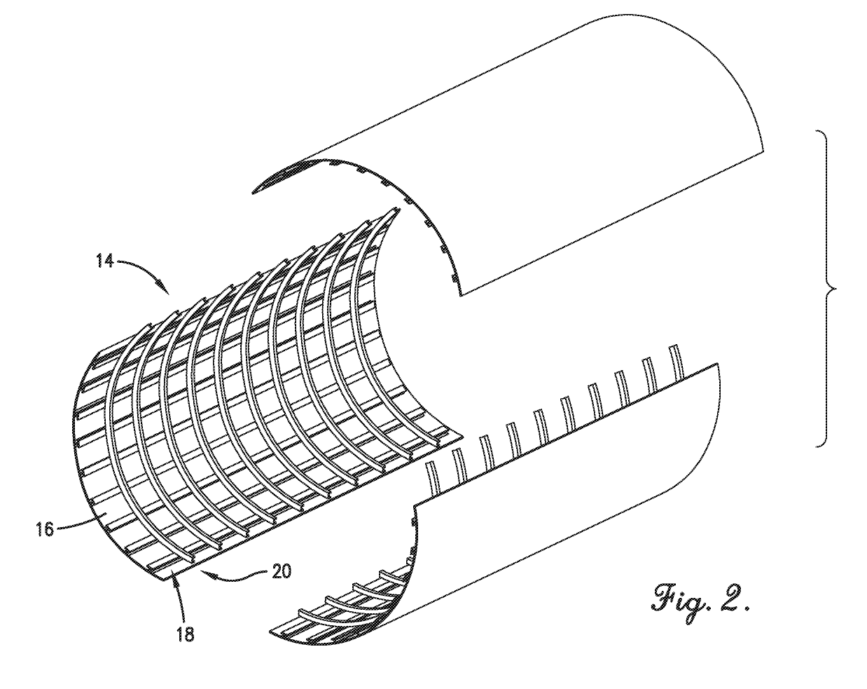

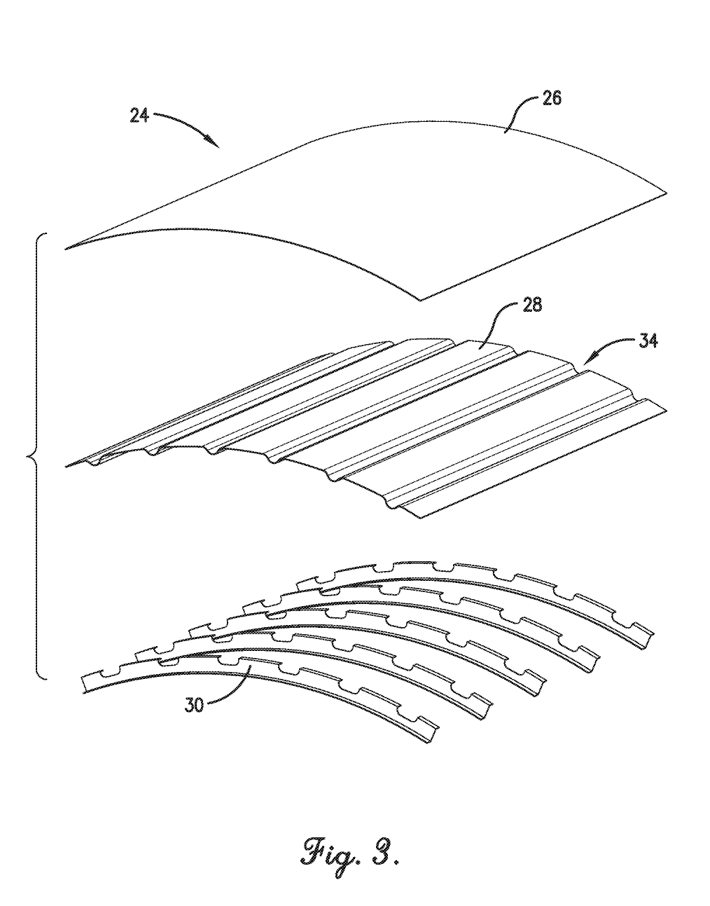

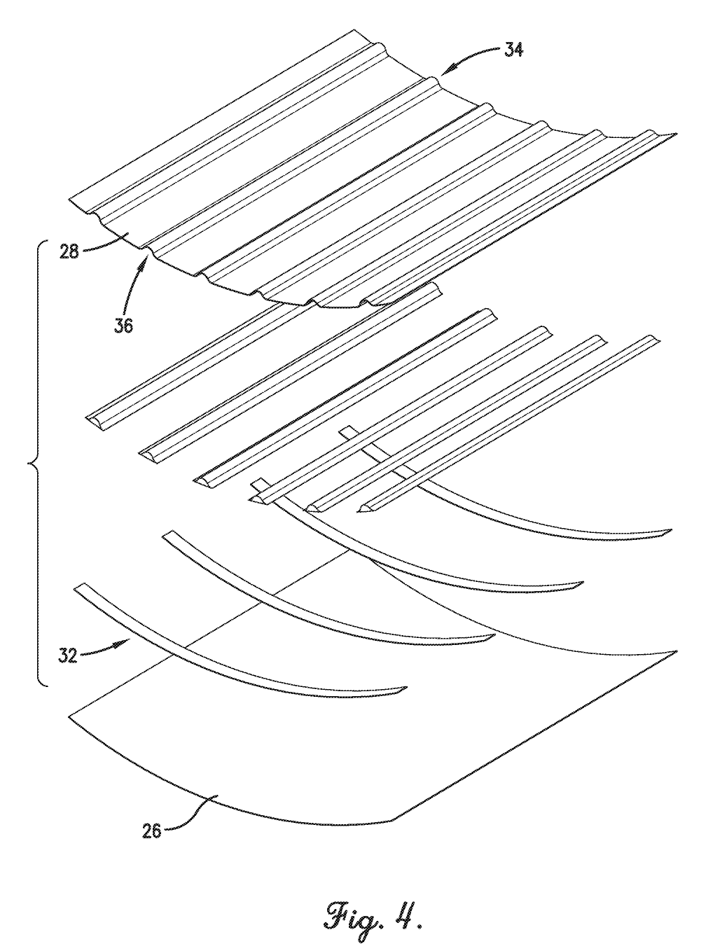

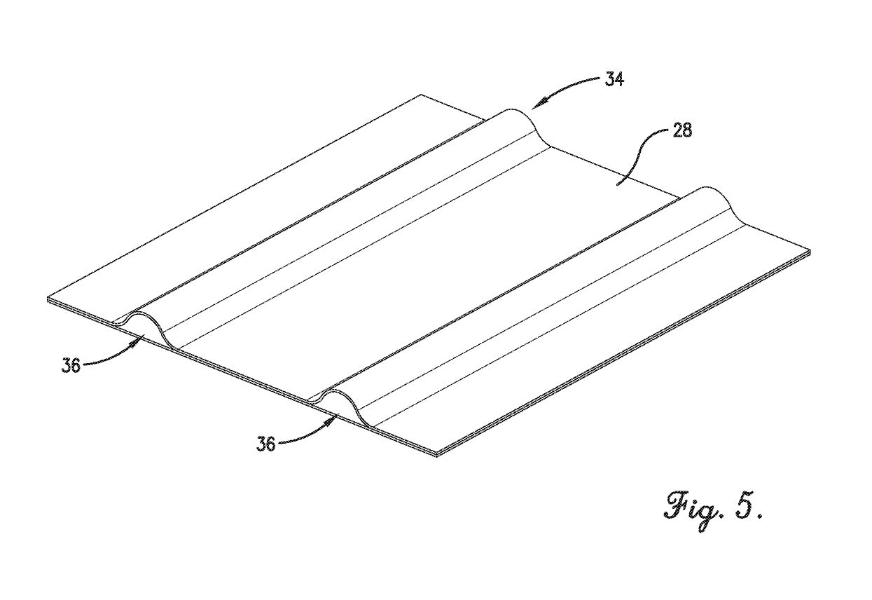

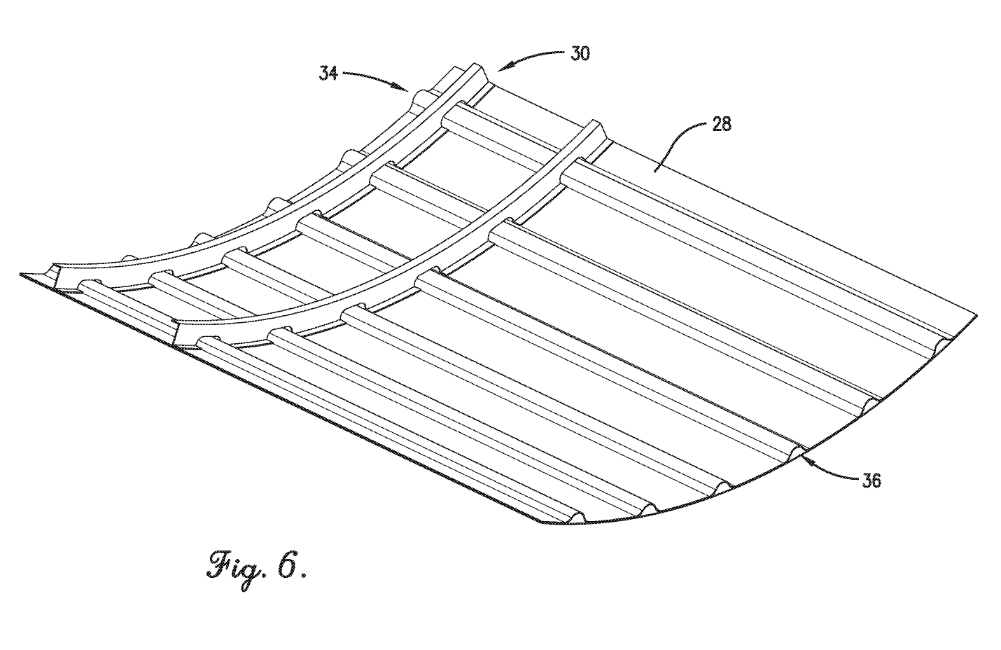

Referring to FIGS. 1 and 2, an example aircraft 10 is shown having a fuselage 12 incorporating an example panel structure 14. The example panel structure 14 may include a skin 16, a plurality of stringers 18, and a plurality of frame members 20. Referring to FIGS. 3-6, an embodiment of a panel structure 24 constructed in accordance with the present invention, which may be used in a fuselage or wing of any aircraft or other bodies of vehicles, may broadly include a skin component 26, a stringer sheet component 28, and a frame component 30. The skin component 26 may be a composite laminate constructed and consolidated in a first process to create an at least partially finished skin component. The skin component 26 may have constant or variable thickness, and may be flat or contoured, as may be desired or needed for a particular application. Changes in thickness may be relatively gentle, with ramp ratios between changes in thickness of 10:1 or greater. In one implementation, one or more tear straps 32 may be interleaved or otherwise incorporated into the skin component 26.

The stringer sheet component 28 may be a composite laminate constructed and consolidated in a second process, which is independent of the first process, to create an at least partially finished stringer sheet component having a plurality of stringers 34. Like the skin component 26, the stringer sheet component 28 may also have constant or variable thickness, as may be desired or needed for a particular application. The individual stringers 34 may take the form of spaced-apart changes in shape to form concavities and/or convexities similar to a corrugated panel, which result in discrete changes in the out-of-plane stiffness of the finished panel structure. The stringer sheet component 28 advantageously minimizes or eliminates the features required by prior art discretely constructed and attached individual stringers for proper form, fit, and functionality, such as edge margins for fastened attachments. Generally, such features are weight-inefficient and parasitic as they do not contribute to the structural performance of the part, so the present technology allows for manufacturing more weight-efficient panels with more fully functional components.

Some or all of the stringers 34 may form cavities 36 either within the stringer sheet 28 itself (i.e., between laminations) or between the stringer sheet 28 and the skin component 26. Some or all of the cavities 36 may be shaped or otherwise designed to meet structural requirements. Embodiments advantageously allow for creating the cavities 36 that mimic traditional stringer design on a contoured tool and without the need for using bladders during the fabrication process. Prior art solutions need bladders to create the cavity during the build process because the skin and stringers are dependently constructed. Bladders are expensive, must be replaced on a regular basis, are prone to leaking, and are typically a single point of failure during the build process. A bladder leak during the final process steps of a traditional build process normally results in scrapping of the part.

Some or all of the cavities 36 may be left hollow (i.e., not filled) or may be partially or fully filled. The filled cavities 36 may be filled with a lightweight closed cell foam or a honeycomb core or substantially any other suitable filler material to satisfy the loading environment and requirements. The filler material may be encapsulated with an adhesive to enable bonding it to the skin and stringer sheet interfaces. Embodiments advantageously provide a significant improvement in structural performance by filling some or all of the cavities 36 with the lightweight material. Filling the cavities 36 allows for significantly increasing the performance of the panel structure 24 for impact, crippling, and column stability in a more weight-efficient manner. The filler material may be placed only where needed to meet requirements. This allows for increasing the performance of the panel structure without adding additional plies of composite material, thereby providing a significant reduction in weight. Prior art solutions which use discrete stringers require that the stringer laminate be made thicker to increase structural performance, which increases the weight of the panel structure.

The at least partially finished skin component 26 and the at least partially finished stringer sheet component 28 may be bonded together or otherwise integrated in a third process, which is independent of the first and second processes, to make the panel structure 24. The shapes of the skin and stringer sheet components 26,28 may be such that their surfaces nest together at locations between the concavities and/or convexities which form the stringers 34. In one implementation, the skin component 26 and the stringer sheet component 28 may be bonded together using an adhesive, such as a paste or sheet adhesive. Embodiments advantageously provide an improved interface between the skin and stringer components 26,28 compared to prior art designs. In particular, the bonded surface area is much greater so the threat of stringer-to-skin delaminations is greatly reduced. Prior art solutions to this problem usually involve reducing the strength allowables or adding fastening elements to control disbond propagation.

The skin component 26 and the stringer sheet component 28 may be compositely constructed using the same or different techniques and from the same or different materials. For example, in one implementation, one or both may be constructed using a non-crimped fabric with a resin infused matrix. In another implementation, one or both may be constructed using a prepreg graphite epoxy fabric, unidirectional tape, or a combination thereof (whether in or out of an autoclave). In another implementation, one or both may be constructed using a thermoplastic unidirectional tape or fabric (whether in tan autoclave or in situ). In each of these implementations, the skin and/or stringer sheet components 26,28 may be compositely constructed on respective tools, and in each case the tool side may be either surface, inner or outer, of the skin and/or stringer sheet components 26,28.

In all cases, the skin and stringer sheet components 26,28 may be constructed using independent processes to produce distinct unintegrated parts which may be subsequently integrated in a separate process. As used herein, “independently constructed” does not necessarily mean with different materials, using different techniques, or at different times, but instead means they are not constructed in such a manner that the materials, construction, consolidation, and timing decisions for one component dictate the decisions for the other component. Thus, the skin and stringer components 26,28 may, in fact, be constructed of the same materials, using the same techniques, and/or consolidation processes at the same time out of convenience or practical necessity (e.g., due to material or machine availability or due to overall scheduling constraints), but not as a result of compromises due to dependent construction. By manufacturing the skin and stringer sheet components 26,28 with independent processes, embodiments allow for maximum design flexibility and optimization for each component. In prior art solutions, the skin and stringers are typically constructed using the same or at least compatible materials in a single process, which often requires compromise in the designs and constructions of the components, and a less than optimal overall panel structure.

In that light, the nature of the consolidation process for each of the skin and stringer sheet components may depend on the material(s) of which they are constructed. For example, if the material is a thermoset material then consolidation may include partial or full curing, while if the material is a thermoplastic material then consolidation may include partial or full cooling. Similarly, the nature of the integration process may depend on the material(s) and/or the state of finish. For example, integration may involve bonding finished components together or co-curing or co-cooling partially finished components.

Thus, the resulting panel structure 24 may have a constant laminate thickness between stringer features to provide a cleaner interface with the frame components 30, may have few or no parasitic weight features, may exhibit significant improvement in bond integrity, and can be manufactured without using pressurized bladders.

The frame component 30 may be attached to the integrated skin and stringer sheet components 26,28 in a fourth process which is independent of the first, second, and third processes. The independent construction and subsequent integration of the skin and stringer sheet components 26,28 advantageously provide a cleaner interface for the frame attachment than is provided by prior art construction methods. In prior art panel structures, the frame interface between stringers is challenged by the discrete flanges of the stringers. Either a flat feature using fillers or tab-outs in the stringer flanges have to be created to enable a non-joggled interface to the frame or the frame has to have joggle features in the skin-to-frame attach flange. Both of these solutions increase complexity, cost, and weight in the final structure. The stringer sheet component of the present invention advantageously provides a non-joggled interface to the skin component, which provides significant cost and weight reduction of the panel structure over the prior art.

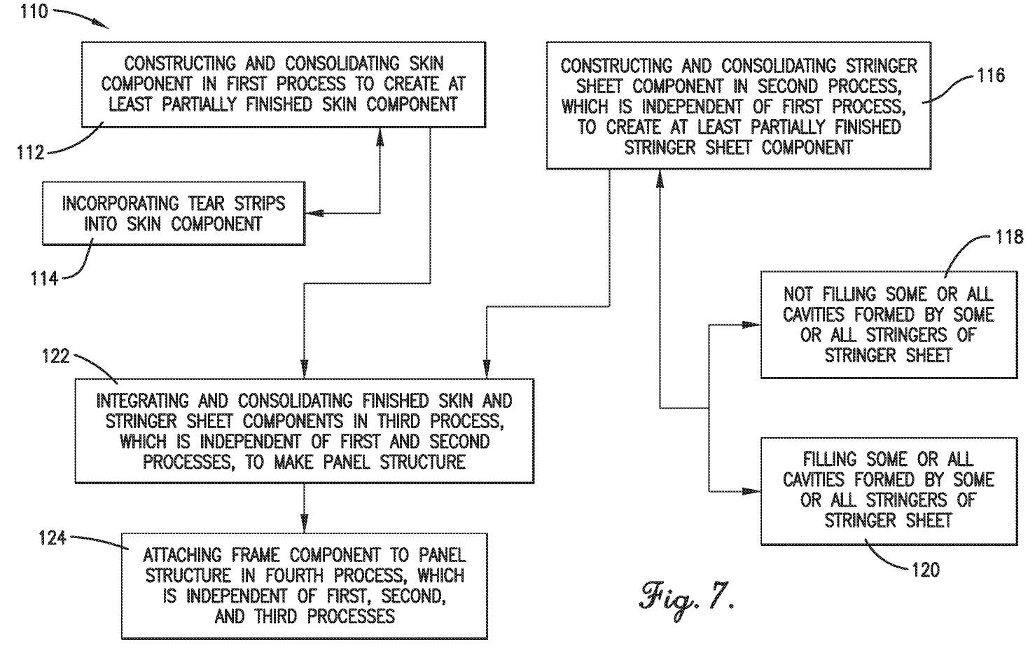

Referring to FIG. 7, an embodiment of a method 110 of making the panel structure 24 may broadly include the following steps. The skin component 26 may be constructed and consolidated in a first process to create an at least partially finished skin component, as shown in 112. In one implementation, the one or more tear straps 32 may be incorporated into the skin component 26, as shown in 114. The stringer sheet component 28 may be constructed and consolidated in a second process, which is independent of the first process, to create an at least partially finished stringer sheet component having the plurality of stringers 34, as shown in 116. Some or all of the stringers 34 may include one or more cavities 36, and some or all of the cavities may be not filled, as shown in 118, or partially or fully filled, as shown in 120. The at least partially finished skin component 26 and the at least partially finished stringer sheet component 28 may then be integrated in a third process, which is independent of the first and second processes, to make the panel structure 24, as shown in 122. The frame component 30 may be attached to the panel structure 24, i.e., to the integrated skin and stringer sheet components 26,28, in a fourth process which is independent of the first, second, and third processes, as shown in 124. The method 110 may include more, fewer, or alternative actions and/or details, including those discussed in the physical description of the panel structure 24.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A method of making a panel structure for a body of a vehicle, the method comprising:
constructing and consolidating a skin component in a first process to create an at least partially finished skin component;
constructing and consolidating a stringer sheet component in a second process, which is independent of the first process, to create an at least partially finished stringer sheet component having a plurality of stringers; and
integrating the at least partially finished skin component and the at least partially finished stringer sheet component in a third process, which is independent of the first and second processes, to make the panel structure.

2. The method of claim 1, wherein the vehicle is an aircraft, and the panel structure is for a fuselage or a wing of the aircraft.

3. The method of claim 1, further including incorporating one or more tear straps into the skin component.

4. The method of claim 1, wherein the skin component and the stringer sheet component are constructed of different materials.

5. The method of claim 1, wherein at least some of the stringers form cavities.

6. The method of claim 5, further including filling at least some of the cavities.

7. The method of claim 6, wherein the at least some of the cavities are filled with a lightweight closed cell foam or a honeycomb core.

8. The method of claim 1, wherein the at least partially finished skin component and the at least partially finished stringer sheet component are integrated by bonding them together using an adhesive.

9. The method of claim 1, further including attaching a frame component to the panel structure in a fourth process which is independent of the first, second, and third processes.

10. A method of making a panel structure for a body of an aircraft, the method comprising:
constructing and consolidating a skin component in a first process to create an at least partially finished skin component;
constructing and consolidating a stringer sheet component in a second process, which is independent of the first process, to create an at least partially finished stringer sheet component having a plurality of stringers, with at least some of the stringers forming cavities;
filling at least some of the cavities formed by the stringers;
bonding with an adhesive the at least partially finished skin component and the at least partially finished stringer sheet component in a third process, which is independent of the first and second processes, to make the panel structure; and
attaching a frame component to the panel structure in a fourth process which is independent of the first, second, and third processes.

11. The method of claim 10, wherein the skin component and the stringer sheet component are constructed of different materials.

12. A panel structure for a body of a vehicle, the panel structure comprising:
a skin component constructed and consolidated in a first process to create an at least partially finished skin component; and
a stringer sheet component constructed and consolidated in a second process, which is independent of the first process, to create an at least partially finished stringer sheet component having a plurality of stringers,
wherein the at least partially finished skin component and the at least partially finished stringer sheet component are integrated in a third process, which is independent of the first and second processes, to make the panel structure.

13. The panel structure of claim 12, wherein the vehicle is an aircraft, and the panel structure is for a fuselage or a wing of the aircraft.

14. The panel structure of claim 12, wherein one or more tear straps are incorporated into the skin component.

15. The panel structure of claim 12, wherein the skin component and the stringer sheet component are constructed of different materials.

16. The panel structure of claim 12, wherein at least some of the stringers form cavities.

17. The panel structure of claim 16, further including filling at least some of the cavities.

18. The panel structure of claim 17, wherein the at least some of the cavities are filled with a lightweight closed cell foam or a honeycomb core.

19. The panel structure of claim 12, wherein the at least partially finished skin component and the at least partially finished stringer sheet component are integrated by bonding them together using an adhesive.

20. The panel structure of claim 12, further including a frame component which is attached to the panel structure in a fourth process which is independent of the first, second, and third processes.
